(19) United States
(12) Patent Application Publication
(10) Pub. No.: US 2026/0135259 A1
(43) Pub. Date: May 14, 2026

(54) BATTERY AND METHOD FOR MANUFACTURING THE SAME

(71) Applicant: TOYOTA JIDOSHA KABUSHIKI KAISHA, Toyota-shi (JP)

(72) Inventor: Tsuyoshi EHARA, Toyota-shi (JP)

(73) Assignee: TOYOTA JIDOSHA KABUSHIKI KAISHA, Toyota-shi (JP)

(21) Appl. No.: 19/273,563

(22) Filed: Jul. 18, 2025

(30) Foreign Application Priority Data
Nov. 11, 2024 (JP) 2024-196991

(51) Int. Cl. H01M 50/486; H01M 10/0525; H01M 10/058; H01M 10/653; H01M 50/107; H01M 50/474; H01M 50/477

(52) U.S. Cl. CPC H01M 50/486; H01M 10/0525; H01M 10/058; H01M 10/653; H01M 50/107; H01M 50/474; H01M 50/477

(57) ABSTRACT

A battery includes an electrode laminate, an outer casing that houses the electrode laminate, and a thermally conductive resin member disposed between the electrode laminate and the outer casing. A length of a surface of the thermally conductive resin member in contact with the electrode laminate is larger than a length of a surface of the electrode laminate in contact with the thermally conductive resin member.

### CROSS-REFERENCE TO RELATED APPLICATION

This application claims priority to Japanese Patent Application No. 2024-196991 filed on Nov. 11, 2024. The disclosure of the above-identified application, including the specification, drawings, and claims, is incorporated by reference herein in its entirety.

### BACKGROUND

### 1. Technical Field

The present disclosure relates to a battery and a method for manufacturing the battery.

### 2. Description of Related Art

An all-solid-state battery described in Japanese Unexamined Patent Application Publication No. 2020-113496 (JP 2020-113496 A) is an example of an all-solid-state battery in which an electrode laminate is enclosed in an outer casing and a heat transfer material is disposed in contact with the electrode laminate inside the outer casing. JP 2020-113496 A discloses an all-solid-state battery cell in which an electrode laminate is enclosed in an outer casing. The electrode laminate includes a current collecting tab extending from an end thereof. The current collecting tab is connected to a terminal extending from an end of the all-solid-state battery cell. A first heat transfer material is disposed inside the outer casing in contact with the electrode laminate and the outer casing.

### SUMMARY

The related-art battery in which the heat transfer material is disposed has a problem in that the position of the electrode laminate varies when the heat transfer material is disposed inside the outer casing.

The present disclosure has been made in view of the above circumstances, and has an object to provide a battery that is excellent in suppressing positional variation of an electrode laminate, and a method for manufacturing the battery.

Means for solving the above problem includes the following aspects.
<1>A battery includes an electrode laminate, an outer casing that houses the electrode laminate, and a thermally conductive resin member disposed between the electrode laminate and the outer casing. A length of a surface of the thermally conductive resin member in contact with the electrode laminate is larger than a length of a surface of the electrode laminate in contact with the thermally conductive resin member.
<2>In the battery according to <1>, the thermally conductive resin member is disposed to cover the surface of the electrode laminate in contact with the thermally conductive resin member and part of two surfaces of the electrode laminate that are connected to the surface.
<3>The battery according to <1>or <2>further includes a current collecting tab on a surface of the electrode laminate on a short side.
<4>The battery according to any one of <1>to <3>is a solid-state battery.
<5>In the battery according to any one of <1>to <4>, the outer casing is a can-shaped outer casing.
<6>A method for manufacturing the battery according to any one of <1>to <5>includes bonding the electrode laminate and the thermally conductive resin member under pressure.

According to the present disclosure, it is possible to provide the battery that is excellent in suppressing the positional variation of the electrode laminate, and the method for manufacturing the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view of a state before an electrode laminate and a thermally conductive resin member are bonded under pressure when a related-art battery is manufactured;

FIG. 2 is a schematic sectional view showing an example of the related-art battery;

FIG. 3 is a schematic sectional view of a state before an electrode laminate and a thermally conductive resin member are bonded under pressure when an example of a battery according to the present disclosure is manufactured; and

FIG. 4 is a schematic sectional view showing the example of the battery according to the present disclosure.

### DETAILED DESCRIPTION OF EMBODIMENTS

Hereinafter, the battery and the method for manufacturing the battery according to the present disclosure will be described in detail with reference to the drawings. Each drawing shown below is a schematic drawing, and the size and shape of each part are exaggerated as appropriate to facilitate understanding.

### Battery

The battery according to the present disclosure includes an electrode laminate, an outer casing that houses the electrode laminate, and a thermally conductive resin member disposed between the electrode laminate and the outer casing. A length of a surface of the thermally conductive resin member in contact with the electrode laminate is larger than a length of a surface of the electrode laminate in contact with the thermally conductive resin member.

The battery according to the present disclosure is preferably a solid-state battery, and more preferably an all-solid-state battery. The solid-state battery may include an all-solid-state battery including a solid electrolyte between electrodes as an electrolyte, and the solid electrolyte may contain an electrolyte solution in an amount of less than 10 mass % with respect to the total amount of the electrolyte.

Hereinafter, a method for manufacturing a battery according to an embodiment of the present disclosure will be described with reference to the drawings.

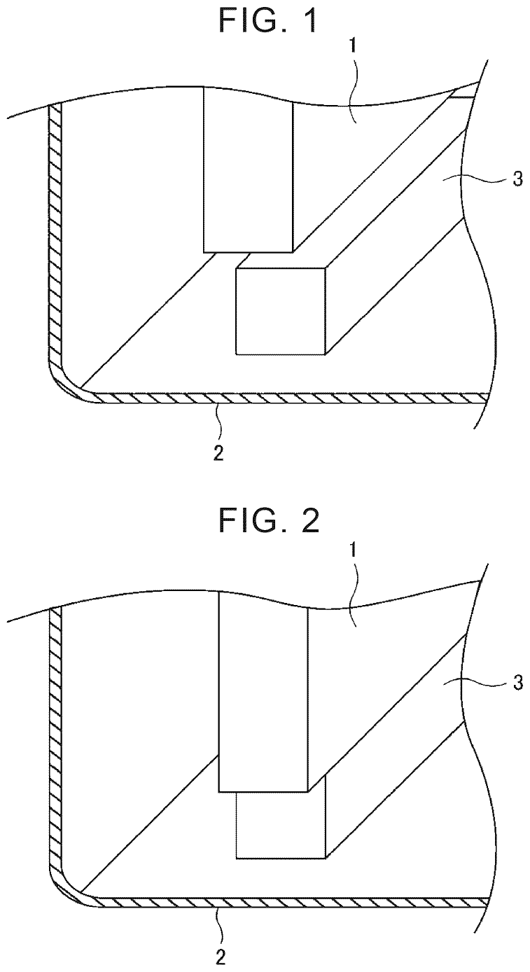

FIG. 1 is a schematic sectional view of a state before an electrode laminate 1 and a thermally conductive resin member 3 are bonded under pressure when a related-art battery is manufactured.

FIG. 2 is a schematic sectional view showing an example of the related-art battery.

FIG. 1 shows a state in which the thermally conductive resin member 3 is disposed inside an outer casing 2 and the electrode laminate 1 has not yet been bonded under pressure.

In FIG. 2, the thermally conductive resin member 3 and the electrode laminate 1 in FIG. 1 are bonded under pressure.

In FIGS. 1 and 2, the length of the surface of the thermally conductive resin member 3 in contact with the electrode laminate 1 is smaller than the length of the surface of the electrode laminate 1 in contact with the thermally conductive resin member 3.

In such a configuration, when the thermally conductive resin member 3 and the electrode laminate 1 are bonded under pressure, the electrode laminate 1 is likely to be misaligned particularly in the longitudinal direction of the surface of the electrode laminate 1 in contact with the thermally conductive resin member 3, resulting in positional variation of the electrode laminate 1.

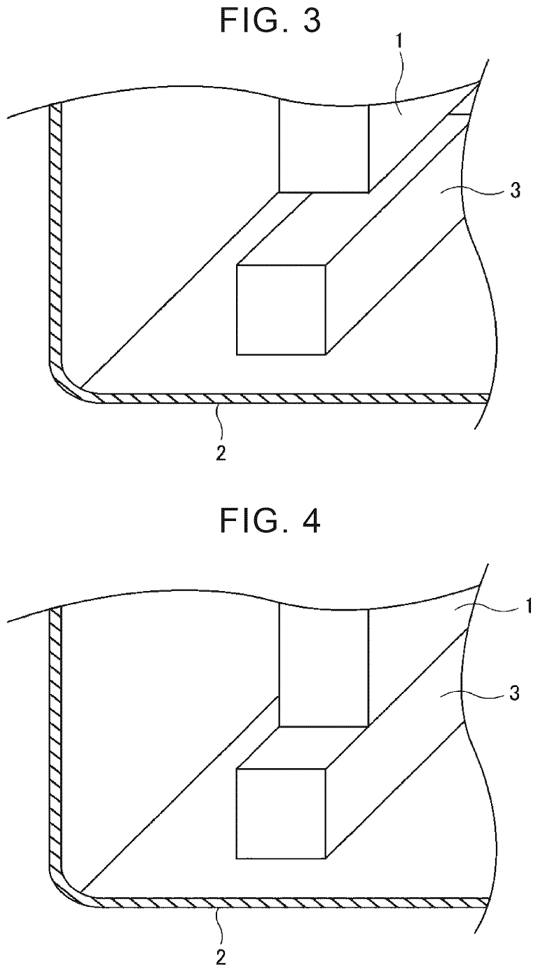

FIG. 3 is a schematic sectional view of a state before an electrode laminate 1 and a thermally conductive resin member 3 are bonded under pressure when an example of the battery according to the present disclosure is manufactured.

FIG. 4 is a schematic sectional view showing the example of the battery according to the present disclosure.

FIG. 3 shows a state in which the thermally conductive resin member 3 is disposed inside an outer casing 2 and the electrode laminate 1 has not yet been bonded under pressure.

In FIG. 4, the thermally conductive resin member 3 and the electrode laminate 1 in FIG. 3 are bonded under pressure.

In FIGS. 3 and 4, the length of the surface of the thermally conductive resin member 3 in contact with the electrode laminate 1 is larger than the length of the surface of the electrode laminate 1 in contact with the thermally conductive resin member 3.

In such a battery according to the present disclosure, when the thermally conductive resin member 3 and the electrode laminate 1 are bonded under pressure, the surface of the thermally conductive resin member 3 in contact with the electrode laminate 1 is compressed to the shape of the electrode laminate 1. At the end of the electrode laminate 1, a portion of the thermally conductive resin member 3 in contact with the end of the electrode laminate 1 holds the end of the electrode laminate 1, thereby suppressing misalignment of the electrode laminate 1 particularly in the longitudinal direction of the surface of the electrode laminate 1 in contact with the thermally conductive resin member 3, and suppressing positional variation of the electrode laminate 1.

In the configuration shown in FIGS. 3 and 4, analysis was actually conducted on the longitudinal displacement (misalignment) of the surface of the electrode laminate 1 in contact with the thermally conductive resin member 3 in a case where the length of the surface of the thermally conductive resin member 3 in contact with the electrode laminate 1 is larger by 2.5 mm than the length of the surface of the electrode laminate 1 in contact with the thermally conductive resin member 3. The result was 1.48 ×10−4 mm.

In the configuration shown in FIGS. 1 and 2, analysis was conducted on the longitudinal displacement (misalignment) of the surface of the electrode laminate 1 in contact with the thermally conductive resin member 3 in a case where the length of the surface of the thermally conductive resin member 3 in contact with the electrode laminate 1 is smaller by 3.0 mm than the length of the surface of the electrode laminate 1 in contact with the thermally conductive resin member 3. The result was 1.71 ×10−4 mm.

As described above, the positional variation of the electrode laminate is suppressed in the battery according to the present disclosure.

Although FIGS. 3 and 4 only show the vicinity of one end of each of the thermally conductive resin member 3 and the electrode laminate 1, it is preferable that, at the other end of each of the thermally conductive resin member 3 and the electrode laminate 1 on the opposite side, the length of the surface of the thermally conductive resin member 3 in contact with the electrode laminate 1 be similarly larger than the length of the surface of the electrode laminate 1 in contact with the thermally conductive resin member 3.

From the viewpoint of suppressing the misalignment of the electrode laminate 1, the length of the surface of the thermally conductive resin member 3 in contact with the electrode laminate 1 is larger than the length of the surface of the electrode laminate 1 in contact with the thermally conductive resin member 3 preferably by 0.2 mm or more, more preferably by 1 mm or more, even more preferably by 2 mm or more, and particularly preferably by 4 mm or more and 20 mm or less.

From the viewpoint of suppressing the misalignment of the electrode laminate 1, at each of both longitudinal ends of the surface of the electrode laminate 1 in contact with the thermally conductive resin member 3, the length of the surface of the thermally conductive resin member 3 in contact with the electrode laminate 1 is larger than the length of the surface of the electrode laminate 1 in contact with the thermally conductive resin member 3 preferably by 0.1 mm or more, more preferably by 0.5 mm or more, even more preferably by 1 mm or more, and particularly preferably by 2 mm or more and 10 mm or less.

From the viewpoint of suppressing the misalignment of the electrode laminate 1, the thermally conductive resin member 3 is preferably disposed to cover the surface of the electrode laminate 1 in contact with the thermally conductive resin member 3 and part of the two surfaces of the electrode laminate 1 that are connected to that surface. The two surfaces are preferably two surfaces that face each other and are perpendicular to the longitudinal direction of the surface of the electrode laminate 1 in contact with the thermally conductive resin member 3.

Although there is no particular limitation on the amount of covering of the thermally conductive resin member 3 over the two surfaces, the thermally conductive resin member 3 covers an area at a distance of preferably 0.1 mm or more, more preferably 0.5 mm or more, and particularly preferably 1 mm or more and 100 mm or less from the end of the surface of the electrode laminate 1 in contact with the thermally conductive resin member 3.

The battery according to the present disclosure preferably further includes a current collecting tab on a surface of the electrode laminate 1 on a short side. The surface on the short side is preferably a surface perpendicular to the longitudinal direction of the surface of the electrode laminate 1 in contact with the thermally conductive resin member 3. The current collecting tab preferably extends from a current collector of the electrode laminate 1.

When the current collecting tab has the above configuration, the connection to an external terminal can be stabilized.

The electrode laminate 1 preferably includes at least a current collector, a cathode active material layer, an electrolyte layer, and an anode active material layer.

A specific example of the configuration of the electrode laminate 1 is a laminate in which unit electrode laminates are stacked.

The unit electrode laminate may have any known configuration, and examples thereof include a laminate of a current collector, a cathode active material layer, an electrolyte layer, an anode active material layer, and a current collector, and a laminate of a current collector, a cathode active material layer, an electrolyte layer, an anode active material layer, a current collector, an anode active material layer, an electrolyte layer, a cathode active material layer, and a current collector.

The material, shape, and size of the outer casing 2 are not particularly limited, and may appropriately be selected as desired. Any known configuration may be used as well.

Among these, the outer casing 2 is preferably a can-shaped outer casing, more preferably a can-shaped metal outer casing, and even more preferably a rectangular can-shaped metal outer casing.

The material of the thermally conductive resin member 3 is not particularly limited, and any resin material that can transfer heat generated in the electrode laminate 1 may be used. Any known resin material may be used.

The material of the thermally conductive resin member 3 preferably has insulating properties. As the material of the thermally conductive resin member, a known thermally conductive resin can be used, and a mixture of a resin and a metal filler is also suitable.

The thermally conductive resin member 3 is not particularly limited, and may be in a sheet form or a paste form.

As shown in FIG. 4, the battery according to the present disclosure preferably has an internal space, and the thermally conductive resin member 3 is preferably in contact with the space. Since the thermally conductive resin member 3 is in contact with the space, the heat dissipation efficiency is improved, and the efficiency of cooling of the electrode laminate 1 is improved.

The method for manufacturing the battery according to the present disclosure preferably includes a step of bonding the electrode laminate 1 and the thermally conductive resin member 3 under pressure. According to the above aspect, the effects of the present disclosure can be exhibited more effectively.

The pressure and temperature during the pressure bonding are not particularly limited, and can be selected as appropriate depending on the materials of the electrode laminate 1 and the thermally conductive resin member 3 to be used, etc.

The battery according to the present disclosure may include a laminate sheet that covers the battery with a bipolar electrode including a cathode active material layer on one side of a current collector and an anode active material layer on the opposite side of the current collector foil, and a side member (e.g., a terminal), and that is thermally welded to the side member.

### Members Constituting Battery

As the current collector, for example, an aluminum foil, a copper foil, a nickel foil, a titanium foil, or a stainless steel foil can be used. The thickness of the current collector may be, for example, 1μm to 100μm.

The thickness of each of the current collector, the cathode active material layer, the anode active material layer, etc., is an average of values measured at 10 points selected as appropriate.

The cathode active material layer contains a cathode active material that can store and release charge carriers such as lithium ions. As the cathode active material, any material available as a cathode active material for lithium ion secondary batteries may be used, such as a lithium composite metal oxide having a layered rock salt structure, a metal oxide having a spinel structure, or a polyanion compound. Two or more kinds of cathode active material may be used in combination. In the present embodiment, the cathode active material layer contains olivine lithium iron phosphate (LiFePO₄) as a composite oxide.

The anode active material layer can be made of any element, alloy, or compound that can store and release charge carriers such as lithium ions, without any particular limitations. Examples of the anode active material include Li, carbon, a metal compound, an element that can be alloyed with lithium, and a compound thereof. Examples of carbon include natural graphite, artificial graphite, hard carbon (hardly graphitizable carbon), and soft carbon (easily graphitizable carbon). Examples of artificial graphite include highly oriented graphite and mesocarbon microbeads. Examples of the element that can be alloyed with lithium include silicon and tin. In the present embodiment, the anode active material layer contains graphite as a carbon-based material.

Each of the cathode active material layer and the anode active material layer may further contain a conductive aid for increasing electrical conductivity, a binder, an electrolyte (polymer matrix, ion-conductive polymer, electrolyte solution, etc.), an electrolyte supporting salt (lithium salt) for increasing ion conductivity, etc. The components contained in the cathode active material layer and the anode active material layer, or the blending ratio of the components, and the thicknesses of the cathode active material layer and the anode active material layer are not particularly limited, and public knowledge about lithium ion secondary batteries can be referred to as appropriate. The thickness of each of the cathode active material layer and the anode active material layer is, for example, 2μm to 150μm. To form the cathode active material layer or the anode active material layer on the surface of the current collector, a known method such as a roll coating method may be used. To improve the thermal stability of the cathode active material layer or the anode active material layer, a heat-resistant layer may be provided on the surface (one or both sides) of the current collector or on the surface of the cathode active material layer or the anode active material layer. The heat-resistant layer contains, for example, inorganic particles and a binder, and may also contain additives such as a thickener.

The conductive aid is added to increase the electrical conductivity of the cathode active material layer or the anode active material layer. The conductive aid is, for example, acetylene black, carbon black, or graphite.

Examples of the binder include fluorine-containing resins such as polyvinylidene fluoride, polytetrafluoroethylene, and fluorine rubber, thermoplastic resins such as polypropylene and polyethylene, imide resins such as polyimide and polyamide-imide, alkoxy silyl group-containing resins, acrylic resins such as poly(meth)acrylic acid, styrene butadiene rubber (SBR), carboxymethyl cellulose, alginates such as sodium alginate and ammonium alginate, water-soluble cellulose ester crosslinked bodies, and starch-acrylic acid graft polymers. These binders may be used alone or in combination. The solvent may be, for example, water or N-methyl-2-pyrrolidone (NMP).

The electrolyte layer (separator) is a member that is disposed between the cathode active material layer and the anode active material layer to separate the cathode active material layer from the anode active material layer, thereby preventing a short circuit due to contact between the two electrodes and allowing charge carriers such as lithium ions to pass. The electrolyte layer prevents a short circuit between adjacent bipolar electrodes when the bipolar electrodes are stacked.

The electrolyte layer may be, for example, a porous sheet or a nonwoven fabric containing a polymer that absorbs and retains the electrolyte. Examples of the material of the electrolyte layer include polypropylene, polyethylene, polyolefin, and polyester. The electrolyte layer may have a single-layer structure or a multi-layer structure. The multi-layer structure may include, for example, an adhesive layer, a ceramic layer serving as a heat-resistant layer, etc. The electrolyte layer may be impregnated with an electrolyte, or the electrolyte layer itself may be composed of an electrolyte such as a polymer electrolyte or an inorganic electrolyte.

Examples of the electrolyte impregnated in the electrolyte layer include a liquid electrolyte (electrolyte solution) containing a non-aqueous solvent and an electrolyte salt dissolved in the non-aqueous solvent, and a polymer gel electrolyte containing an electrolyte retained in a polymer matrix.

When the electrolyte layer is impregnated with an electrolyte solution, the electrolyte salt may be a known lithium salt such as LiClO₄, LiAsF₆, LiPF₆, LiBF₄, LiCF₃SO₃, LiN(FSO₂)₂, or LiN(CF₃SO₂)₂. As the non-aqueous solvent, known solvents such as cyclic carbonates, cyclic esters, chain carbonates, chain esters, or ethers can be used. Two or more kinds of these known solvent materials may be used in combination.

The side member may be a current collecting side member. The current collecting side member refers to a side member including a current collecting portion at least in part. The current collecting portion is, for example, electrically connected to a tab of the battery. The current collecting side member may be the current collecting portion as a whole, or may be the current collecting portion in part. Examples of the material of the side member include metals such as stainless steel (SUS). The shape of the side member is not particularly limited, and may be, for example, a rectangular parallelepiped shape.

The laminate sheet includes at least a metal layer, and preferably further includes a weldable resin layer on the surface of the metal layer near the side member. The laminate sheet may also include a protective layer on the surface of the metal layer opposite to the side member.

Examples of the material of the weldable resin layer include an olefin resin such as polypropylene (PP) or polyethylene (PE). Examples of the material of the metal layer include aluminum, aluminum alloy, and stainless steel. Examples of the material of the protective layer include polyethylene terephthalate (PET) and nylon.

The thickness of the weldable resin layer is, for example, 40μm or more and 100μm or less. The thickness of the metal layer is, for example, 30μm or more and 60μm or less. The thickness of the protective layer is, for example, 20μm or more and 60μm or less. The overall thickness of the laminate sheet is, for example, 70μm or more and 220μm or less.

The battery includes a resin layer (e.g., a tab film) disposed on the surface of a pair of side faces of the side member. The resin layer is provided to cover part of the surface of the side member and to be interposed between the side member and the laminate sheet.

Examples of the material of the resin layer include an olefin resin such as polypropylene (PP) or polyethylene (PE). The thickness of the resin layer is, for example, 40 μm or more and 100μm or less.

The battery according to the present disclosure is typically a lithium ion secondary battery. The battery is applied to, for example, a power supply for vehicles such as a hybrid electric vehicle (HEV), a plug-in hybrid electric vehicle (PHEV), a battery electric vehicle (BEV), a gasoline automobile, and a diesel automobile. In particular, the battery is preferably used as a power supply for driving a hybrid electric vehicle (HEV), a plug-in hybrid electric vehicle (PHEV), or a battery electric vehicle (BEV). The battery according to the present disclosure may be used as a power supply for moving bodies other than vehicles (e.g., trains, ships, and aircraft), or may be used as a power supply for electrical products such as information processing devices.

The present disclosure is not limited to the above embodiment. The above embodiment is illustrative, and anything having substantially the same configuration as, and having similar functions and effects to, the technical idea described in the claims of the present disclosure is included in the technical scope of the present disclosure.

What is claimed is:

1. A battery comprising:
an electrode laminate;
an outer casing that houses the electrode laminate; and
a thermally conductive resin member disposed between the electrode laminate and the outer casing, wherein
a length of a surface of the thermally conductive resin member in contact with the electrode laminate is larger than a length of a surface of the electrode laminate in contact with the thermally conductive resin member.

2. The battery according to claim 1, wherein the thermally conductive resin member is disposed to cover the surface of the electrode laminate in contact with the thermally conductive resin member and part of two surfaces of the electrode laminate that are connected to the surface.

3. The battery according to claim 1, further comprising a current collecting tab on a surface of the electrode laminate on a short side.

4. The battery according to claim 1, wherein the battery is a solid-state battery.

5. The battery according to claim 1, wherein the outer casing is a can-shaped outer casing.

6. A method for manufacturing the battery according to claim 1, the method comprising bonding the electrode laminate and the thermally conductive resin member under pressure.
